(19) United States
(12) Patent Application Publication
(10) Pub. No.: US 2010/0052634 A1
(43) Pub. Date: Mar. 4, 2010

(54) DRIVING CIRCUIT FOR IMPROVING THE LOADING TRANSIENT PERFORMANCE OF A POWER CONVERTER

(76) Inventor: Li-Cheng CHEN, Kaohsiung City (TW)

Correspondence Address: NORTH AMERICA INTELLECTUAL PROPERTY CORPORATION, P.O. BOX 506, MERRIFIELD, VA, 22116, US

(21) Appl. No.: 12/202,344

(22) Filed: Sep. 1, 2008

(51) Int. Cl. G05F 1/565

(52) U.S. Cl. 323/280

(57) ABSTRACT

A driving circuit that improves the loading transient performance of a power converter is provided. The driving circuit comprises an input unit, an output unit, a reference current generating unit, and a discharging unit. The input unit receives a first voltage signal and a second voltage signal. The first voltage signal has a first voltage V₁ and the second voltage signal has a second voltage V₂. The output unit outputs a third voltage signal. The input unit, the output unit, and the reference current generating unit form an error amplifier. A discharging unit has a discharging current path. When V₁ is larger than (1+a)*V₂, the discharging current path is turned ON. When V₁ is smaller than (1+b)*V₂, the discharging current path is turned OFF.

### BACKGROUND OF THE INVENTION

1. Field of the Invention

The present invention relates to a driving circuit. More particularly, the present invention relates to a driving circuit for improving the loading transient performance of a power converter.

2. Description of the Related Art

FIG. 1 is a circuit diagram showing a conventional power converter 10. In the example shown in FIG. 1, the power converter 10 is used to regulate an output voltage Vₒ so as to provide an output current to a load R_{L}. An error amplifier 12 comprises a non-inverting input terminal for receiving a reference voltage signal Vᵣ, and an inverting input terminal for receiving a feedback voltage signal V_{fb}. An adjusting circuit 11 is controlled by an error signal Vₑₒ which is outputted from the output terminal of the error amplifier 12. The output terminal of the adjusting circuit 11 is coupled to a voltage divider made by resistors R₁₁ and R₁₂, a capacitor C_{O}, and the load R_{L}. The connecting point of resistors R₁₁ and R₁₂ provides a voltage [R₁₂/(R₁₁+R₁₂)]*V_{O} to the feedback voltage signal V_{fb}. When the power converter 10 is operated under the loading transient condition, the ripple voltage of the output voltage V_{O} will be increased. That is, when the load R_{L} changes from the heavy loading to the light loading, or changes from the light loading to the heavy loading, the ripple voltage of the output voltage V_{O} will be increased as a result.

### SUMMARY OF THE INVENTION

In view of the above-mentioned problems, an object of the present invention is to provide a driving circuit, capable of improving the loading transient performance of a power converter.

According to the present invention, the driving circuit comprises an input unit, an output unit, a reference current generating unit, and a discharging unit. The input unit receives a first voltage signal and a second voltage signal. The first voltage signal has a first voltage V₁ and the second voltage signal has a second voltage V₂. The output unit outputs a third voltage signal. The output unit is coupled to the input unit. The reference current generating unit is coupled to the input unit and the output unit. The input unit, the output unit, and the reference current generating unit form an error amplifier. The discharging unit has a discharging current path. The discharging unit is coupled to the output unit. When V₁ is larger than (1+a)*V₂, the discharging current path is turned ON. When V₁ is smaller than (1+b)*V₂, the discharging current path is turned OFF.

### BRIEF DESCRIPTION OF THE DRAWINGS

The above-mentioned and other objects, features, and advantages of the present invention will become apparent with reference to the following descriptions and accompanying drawings, wherein:

FIG. 1 is a circuit diagram showing a conventional power converter;

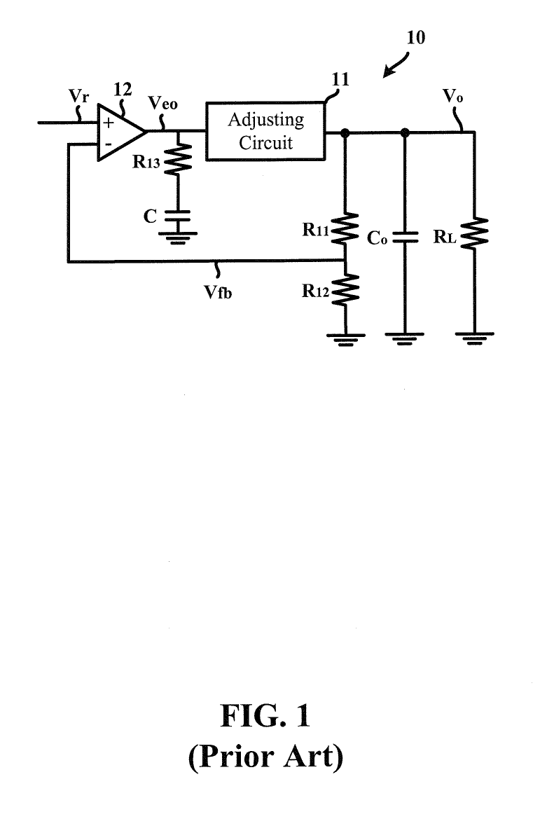

FIG. 2 is a circuit diagram showing a power converter according to the present invention;

FIG. 3 is a detailed circuit diagram showing a driving circuit according to the present invention;

FIG. 4 is a timing chart showing some related signals according to the present invention;

### DETAILED DESCRIPTION OF THE INVENTION

A preferred embodiment according to the present invention will be described in detail with reference to the drawings.

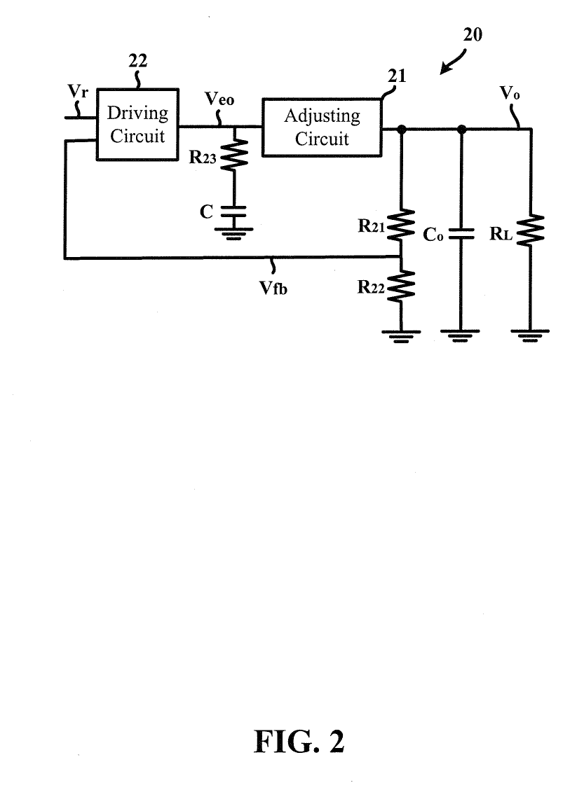

FIG. 2 is a circuit diagram showing a power converter 20 according to the present invention. For improving the loading transient performance, a conventional error amplifier is replaced by a driving circuit 22 according to the invention. In the example shown in FIG. 2, the power converter 20 is used to regulate an output voltage V_{O} so as to provide an output current to a load R_{L}. The driving circuit 22 receives a reference voltage signal Vᵣ and a feedback voltage signal V_{fb}. An adjusting circuit 21 is controlled by an error signal Vₑₒ which is outputted from the output terminal of the driving circuit 22. The output terminal of the adjusting circuit 21 is coupled to a voltage divider made by resistors R₂₁ and R₂₂, a capacitor C_{O}, and the load R_{L}. The connecting point of resistors R₂₁ and R₂₂ provides a voltage [R₂₂/(R₂₁+R₂₂)]*V_{O} to the feedback voltage signal V_{fb}.

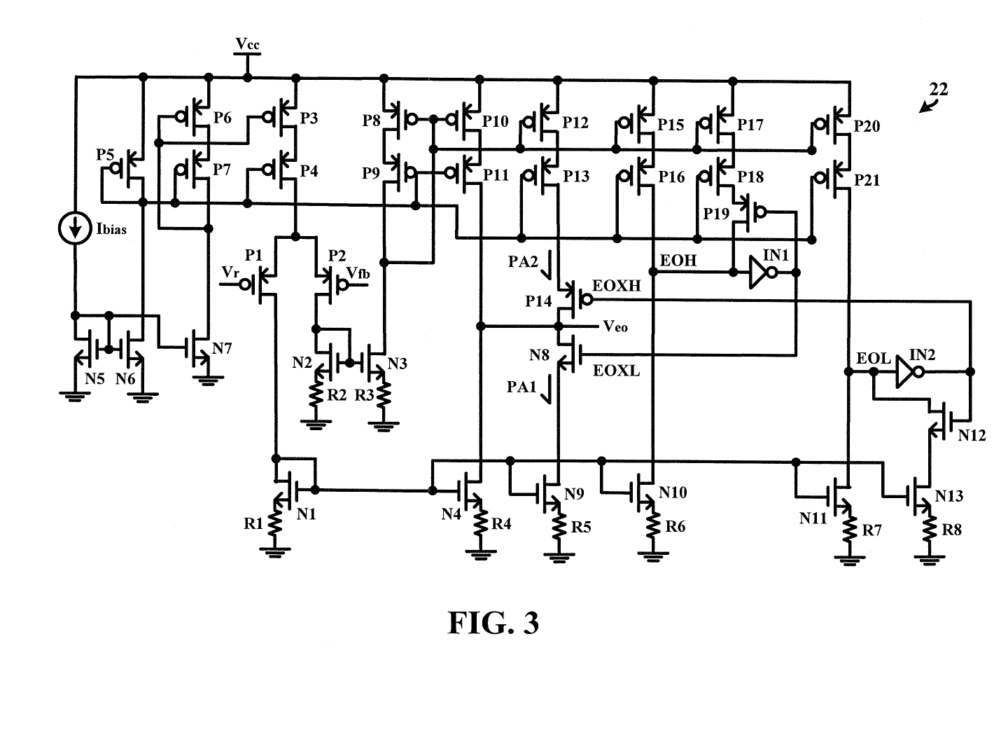

FIG. 3 is a detailed circuit diagram showing the driving circuit 22 according to the present invention. The driving circuit 22 comprises PMOS transistors P1-P21, NMOS transistors N1-N13, resistors R1-R8, inverters IN1-IN2, and a current source I_{bias}. Transistors P1 and P2 form a differential input pair, where the gate of the transistor P1 is coupled to the reference voltage signal Vᵣ and the gate of the transistor P2 is coupled to the feedback voltage signal V_{fb}. Transistors P1-P4, transistors N1-N2, and resistors R1-R2 form an input unit. Transistors P8-P11, transistors N3-N4, and resistors R3-R4 form an output unit so as to generate the error signal Vₑₒ. The output unit is coupled to the input unit. Transistors P5-P7, transistor N5-N7, and the current source I_{bias} form a reference current generating unit. The reference current generating unit is coupled to the input unit and the output unit so as to provide the needed currents. The input unit, the output unit, and the reference current generating unit form an error amplifier. The error amplifier is configured as a transconductance amplifier.

Transistors P12-P14 form a charging unit, where the transistor P12 is coupled to a voltage V_{CC}. Transistors N8-N9 and resistor R5 form a discharging unit, where resistor R5 is coupled to a ground. The discharging unit has a discharging current path PA1 and the charging unit has a charging current path PA2 as shown in FIG. 3. Both the discharging unit and the charging unit are coupled to the output unit. Transistors P15-P19, the transistor N10, the inverter IN1, and the resistor R6 form a first control unit so as to control the discharging current path PA1. The first control unit is coupled to the input unit and the output unit. Transistors P20-P21, transistors N11-N13, the inverter IN2, and resistors R7-R8 form a second control unit so as to control the charging current path PA2. Also, the second control unit is coupled to the input unit and the output unit. The error signal Vₑₒ is coupled to the drain of the transistor P14 and the drain of the transistor N8. The inverter IN1 receives a signal EOH and outputs a signal EOXL. The signal EOH is coupled to the drain of the transistor N10 and the drain of the transistor P19. The signal EOXL is coupled to the gate of the transistor N8 and the gate of the transistor P19. The inverter IN2 receives a signal EOL and outputs a signal EOXH. The signal EOL is coupled to the drain of the transistor P21 and the drain of the transistor N12. The signal EOXH is coupled to the gate of the transistor P14 and the gate of the transistor N12.

Please refer to FIGS. 2-3 for interpreting the operation mode of the driving circuit 22. When the power converter 20 is operated under the stable loading condition, the voltage V₁ of the feedback voltage signal V_{fb} is approximately equal to the voltage V₂ of the reference voltage signal Vᵣ. The resistance of the resistor R6 is designed to be larger than the resistance of the resistor R4, in order that the current flowing through the transistor N10 and the resistor R6 is smaller than the current flowing through the transistor N4 and the resistor R4. As a result, the signal EOH is a high level and the signal EOXL is a low level. At this moment, the transistor N8 is not conducting and the discharging current path PA1 is turned OFF. In addition, the width-to-length ratio of the transistor P10 is designed to be larger than the width-to-length ratio of the transistor P20, in order that the current flowing through transistors P20 and P21 is smaller than the current flowing through transistors P10 and P11. As a result, the signal EOL is a low level and the signal EOXH is a high level. At this moment, the transistor P14 is not conducting and the charging current path PA2 is also turned OFF. To sum up, the first control unit, the second control unit, the discharging unit, and the charging unit have no effect on the stable loading condition.

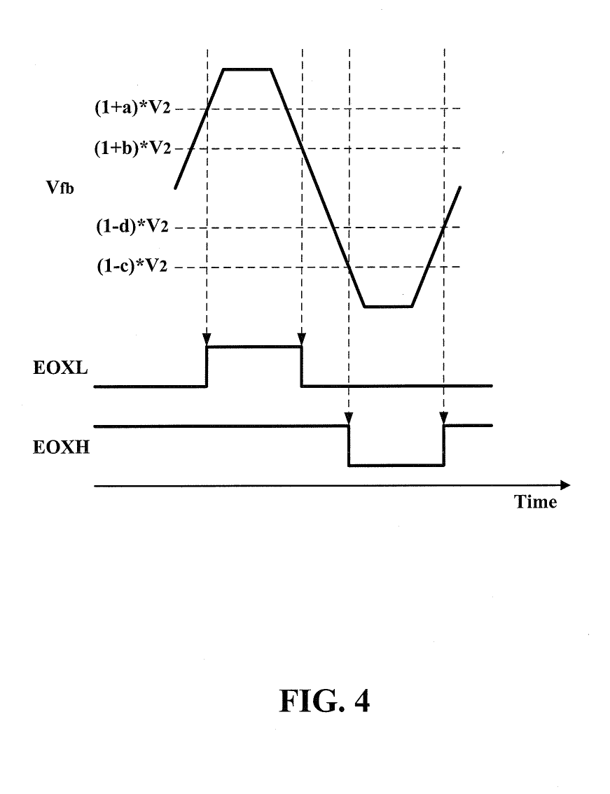

FIG. 4 is a timing chart showing the feedback signal V_{fb}, the signal EOXL, and the signal EOXH according to the present invention. Please refer to FIGS. 2-4 for further interpreting the other operating modes of the driving circuit 22. When the load R_{L} of the voltage converter 20 changes from the heavy loading to the light loading, the voltage V₁ of the feedback voltage signal V_{fb} is larger than the voltage V₂ of the reference voltage signal Vᵣ, resulting that the error signal Vₑₒ begins to decrease. When V₁ is larger than (1+a)*V₂, the signal EOH becomes the low level and the signal EOXL becomes the high level. The transistor N8 is conducting as a result. By turning ON the discharging current path PA1, the error signal Vₑₒ decreases with a faster rate, thereby decreasing the ripple voltage of the output voltage V_{O}. When V₁ is smaller than (1+b)*V₂, the signal EOH becomes the high level and the signal EOXL becomes the low level, where a>b. The transistor N8 is not conducting and thus the discharging current path PA1 is turned OFF. The current path flowing through the transistor P19 forms a hysteresis region so as to avoid the unstable operation of the power converter 20. In this embodiment a is 0.02 and b is 0.01, but the values of a and b are not limited.

When the load R_{L} of the voltage converter 20 changes from the light loading to the heavy loading, the voltage V₁ of the feedback voltage signal V_{fb} is smaller than the voltage V₂ of the reference voltage signal Vᵣ, resulting that the error signal Vₑₒ begins to increase. When V₁ is smaller than (1−c)*V₂, the signal EOL becomes the high level and the signal EOXH becomes the low level. The transistor P14 is conducting as a result. By turning ON the charging current path PA2, the error signal Vₑₒ increases with a faster rate, thereby decreasing the ripple voltage of the output voltage V_{O}. When V₁ is larger than (1−d)*V₂, the signal EOL becomes the low level and the signal EOXH becomes the high level, where c>d. The transistor P14 is not conducting and thus the charging current path PA2 is turned OFF. The current path flowing through the transistor N12 forms the other hysteresis region so as to avoid the unstable operation of the power converter 20. In this embodiment c is 0.02 and d is 0.01, but the values of c and d are not limited.

While the invention has been described by a preferred embodiment, it is to be understood that the invention is not limited to the disclosed embodiment. On the contrary, it is intended to cover various modifications. Therefore, the scope of the appended claims should be accorded the broadest interpretation so as to encompass all such modifications.

What is claimed is:

1. A driving circuit comprising:
an input unit for receiving a first voltage signal and a second voltage signal, wherein the first voltage signal has a first voltage V₁ and the second voltage signal has a second voltage V₂;
an output unit for outputting a third voltage signal, the output unit being coupled to the input unit;
a reference current generating unit, the reference current generating unit being coupled to the input unit and the output unit, wherein the input unit, the output unit, and the reference current generating unit form an error amplifier; and
a discharging unit having a discharging current path, the discharging unit being coupled to the output unit, wherein:
when V₁ is larger than (1+a)*V₂, the discharging current path is turned ON, and
when V₁ is smaller than (1+b)*V₂, the discharging current path is turned OFF, wherein a is larger than b.

2. The driving circuit of claim 1, wherein a is equal to 0.02 and b is equal to 0.01.

3. The driving circuit of claim 1, wherein the driving circuit is applied to a power converter, and V₁ is proportional to the output voltage of the power converter.

4. A driving circuit comprising:
an input unit for receiving a first voltage signal and a second voltage signal, wherein the first voltage signal has a first voltage V₁ and the second voltage signal has a second voltage V₂;
an output unit for outputting a third voltage signal, the output unit being coupled to the input unit;
a reference current generating unit, the reference current generating unit being coupled to the input unit and the output unit, wherein the input unit, the output unit, and the reference current generating unit form an error amplifier; and
a charging unit having a charging current path, the charging unit being coupled to the output unit, wherein:
when V₁ is smaller than (1−c)*V₂, the charging current path is turned ON, and
when V₁ is larger than (1−d)*V₂, the charging current path is turned OFF, wherein c is larger than d.

5. The driving circuit of claim 4, wherein c is equal to 0.02 and d is equal to 0.01.

6. The driving circuit of claim 4, wherein the driving circuit is applied to a power converter, and V₁ is proportional to the output voltage of the power converter.

7. A driving circuit comprising:
an input unit for receiving a first voltage signal and a second voltage signal, wherein the first voltage signal has a first voltage V₁ and the second voltage signal has a second voltage V₂;
an output unit for outputting a third voltage signal, the output unit being coupled to the input unit;
a reference current generating unit, the reference current generating unit being coupled to the input unit and the output unit, wherein the input unit, the output unit, and the reference current generating unit form an error amplifier;
a discharging unit having a discharging current path, the discharging unit being coupled to the output unit; and
a charging unit having a charging current path, the charging unit being coupled to the output unit, wherein:
when V₁ is larger than (1+a)*V₂, the discharging current path is turned ON,
when V₁ is smaller than (1+b)*V₂, the discharging current path is turned OFF,
when V₁ is smaller than (1−c)*V₂, the charging current path is turned ON, and
when V₁ is larger than (1−d)*V₂, the charging current path is turned OFF, wherein a is larger than b and c is larger than d.

8. The driving circuit of claim 7, wherein a is equal to 0.02, b is equal to 0.01, c is equal to 0.02, and d is equal to 0.01.

9. The driving circuit of claim 7, wherein the driving circuit is applied to a power converter, and V₁ is proportional to the output voltage of the power converter.
